(19) United States
(12) Patent Application Publication
(10) Pub. No.: US 2014/0237017 A1
(43) Pub. Date: Aug. 21, 2014

(54) EXTENDING DISTRIBUTED COMPUTING SYSTEMS TO LEGACY PROGRAMS

(71) Applicant: mParallelo Inc., Saratoga, CA (US)

(72) Inventors: Sanjay Adkar, Saratoga, CA (US); Bogdan Mitu, Campbell, CA (US); Manish Singh, Saratoga, CA (US)

(73) Assignee: mParallelo Inc., Saratoga, CA (US)

(21) Appl. No.: 14/180,242

(22) Filed: Feb. 13, 2014

Related U.S. Application Data
(60) Provisional application No. 61/765,630, filed on Feb. 15, 2013.

(51) Int. Cl. H04L 29/08

(52) U.S. Cl. CPC H04L 67/10
USPC 709/201

(57) ABSTRACT

The system provides energy-efficiency of computing nodes in a cluster such that application level compatibility is maintained with legacy programs. This enables clusters to grow in computer capability while optimizing and managing expenses in energy usage, cooling infrastructure and real estate costs. The present technology may leverage existing purpose built parallel processing hardware, such as for example GPU hardware cards, with software to provide the functionality discussed herein. The present technology may create and add to an existing Hadoop cluster, or other distributed data processing framework, an augmented data node with enhanced compute per watt capability using off the shelf parallel processing hardware (e.g., GPU cards) while preserving the application level compatibility with the framework infrastructure.

### CROSS REFERENCE TO RELATED APPLICATIONS

The present application claims the priority benefit of U.S. provisional patent application No. 61/765,630, filed on Feb. 15, 2013, entitled “EXTENDING DISTRIBUTED COMPUTING SYSTEMS TO LEGACY PROGRAMS”, the disclosure of which is incorporated herein by reference.

### BACKGROUND

With the advent of cloud and other network computing architectures, the amount and types of data generated and processed has increased. Several frameworks such as Apache's “Hadoop” framework allows for the distributed processing of large data sets across clusters of computers using simple programming models. With the wide use of such distributed systems to process large amounts of data, there is an increasing need to analyze the data in an energy-efficient manner. Some prior art systems provide data processing at improved performance at low power using purpose-built hardware and software. However, these methods are not compatible at the application level with legacy programs. What is needed is a system an efficient distributed data processing system that is flexible to handle different types of programs.

### SUMMARY

The present technology provides energy-efficiency of computing nodes in a cluster such that application level compatibility is maintained with legacy programs. This enables clusters to grow in computer capability while optimizing and managing expenses in energy usage, cooling infrastructure and real estate costs. The present technology may leverage existing purpose built parallel processing hardware, such as for example GPU hardware cards, with software to provide the functionality discussed herein. The present technology may create and add to an existing Hadoop cluster, or other distributed data processing framework, an augmented data node with enhanced compute per watt capability using “off the shelf” parallel processing hardware (e.g., GPU cards) while preserving the application level compatibility with the framework infrastructure.

In an embodiment, a method for providing a computing node may include accessing a data node in a distributed framework with an additional hardware unit. The hardware may not be currently utilized by the distributed framework. A software module may be installed on the data node to interact with the processing hardware. Performance of the data node may be accelerated within the distributed framework based on the executing software module and the processing hardware.

In an embodiment, a system for providing a computing node may include a processor, memory, and one or more modules stored in memory. The one or more modules may be executable by the processor to access a data node in a distributed framework with processing hardware not utilized by the distributed framework, install a software module on the data node to interact with the processing hardware, and accelerate performance of the data node within the distributed framework based on the executing software module and the processing hardware.

### BRIEF DESCRIPTION OF DRAWINGS

FIG. 1 is a block diagram of an enhanced data node in relation to a framework cluster.

FIG. 2 is block diagram of enhanced data node with a virtualization layer.

FIG. 3 is block diagram of exemplary software modules included in the present technology.

FIG. 4 is an exemplary flowchart for the present technology.

FIG. 5 is an exemplary data flow for CPU operation.

FIG. 6 is a block diagram of a device for implementing the present technology.

### DETAILED DESCRIPTION

The present technology provides energy-efficiency of computing nodes in a cluster in a distributed data processing framework, such as a Hadoop framework (which may be referred to herein for purposes of illustration but is not intended to be limiting), such that application level compatibility is maintained with legacy programs. The invention may be implemented at least in part by one or more components of software that manage processing hardware, such as for example graphic processing unit (GPU) cards, a central processing unit (CPU), or other processing hardware. For example, the invention may include one or more software modules that act as a processing accelerator by utilizing the cores within a GPU card to provide more efficient processing by a system.

The accelerator of the present invention may be transparent to the Hadoop system framework which provides tasks to the cluster on which the accelerator software is installed. The accelerator may include one or more modules which manage communications with the Hadoop layer and processing hardware such as a GPU, manage concurrently run tasks, monitor and adapt the balance of processing load, and perform other functions discussed in more detail below.

The present technology may also include one or more translators, such as Java to C language translators. For example, each translator may convert a Java program to an intermediate state that can be compiled to the parallel processing hardware. In some embodiments, one translator may be used per parallel processing hardware type. HTML based Task monitoring tools may allow the user to monitor the progress of the parallel tasks implemented on the enhanced data node relative to the task on the framework cluster.

The present technology is flexible and may be software driven, and is intended to be used for multiple software frameworks. References to a particular framework, such as Apache Hadoop software framework, or particular processing hardware, such as GPUs, are for exemplary purposes only and are not intended to limit the scope of the invention.

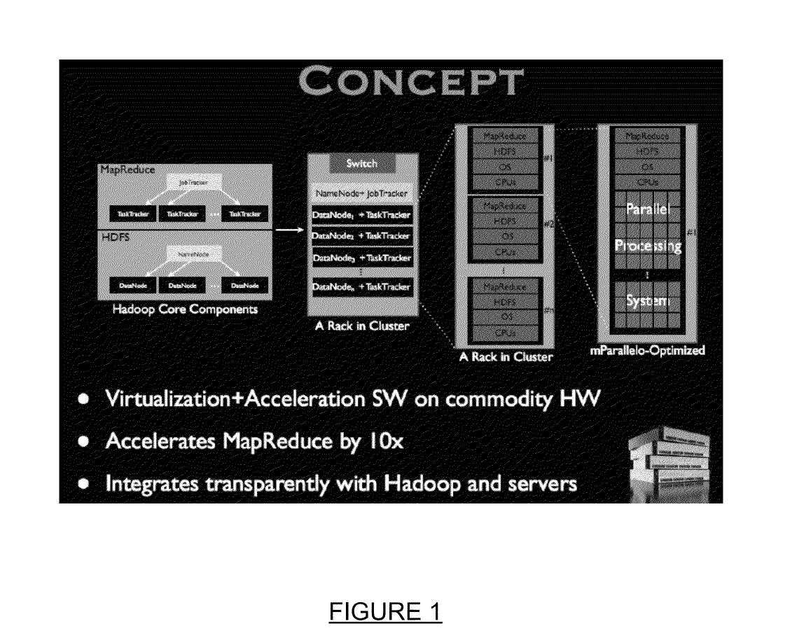

FIG. 1 is a block diagram of an enhanced data node in relation to a framework cluster. Purpose-built machines may be initially created with the same processor and operating systems as all other machine in the cluster. At this stage, if the nodes were to be added to the cluster, they may come up as homogeneous nodes and the cluster would continue to operate homogeneously. The nodes may be modified by adding additional hardware, such as a purpose-built processor, memory, appropriate coupling interfaces to the existing CPUs and operating systems(OS). FIG. 1 includes framework (in this instance, Hadoop framework) core components, a rack in a cluster, and a data node optimized by the accelerator software of the present invention. The OS coupling is accomplished via virtualization software written in the form of device drivers specifically written to operate the purpose built software optimally.

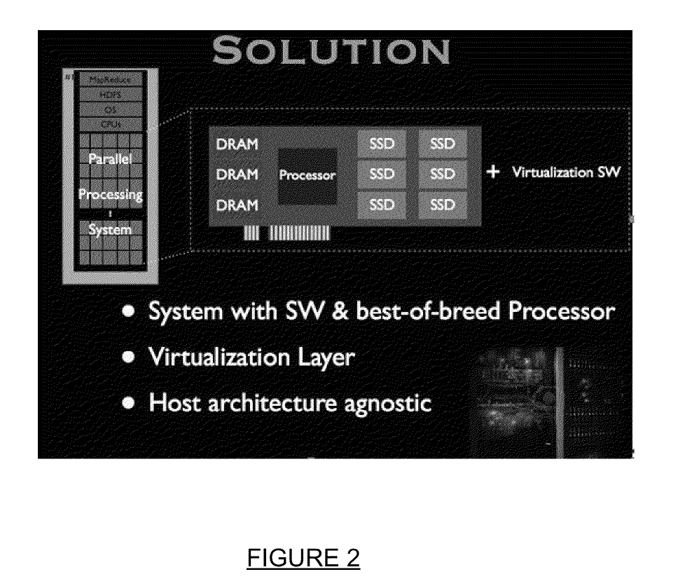

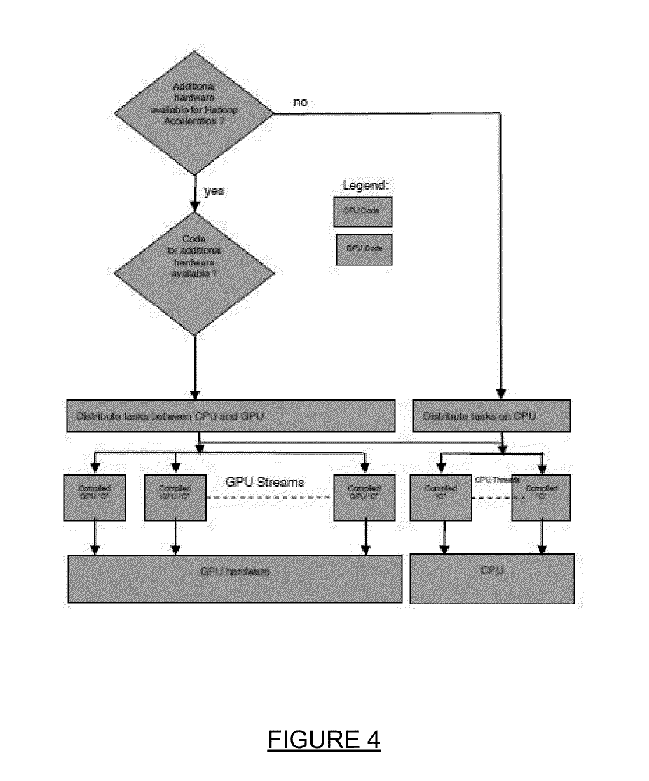

FIG. 2 is a block diagram of an enhanced data node with a virtualization layer. The device drivers communicate with the node cluster management software to reconfigure it to account for the enhancements provided by the purpose-built hardware. An additional layer may be implemented on top of the virtualization layer which probes the hardware and the software to determine if the purpose-built hardware is present. It directs the flow of the program accordingly. This is discussed in more detail below with respect to FIG. 4.

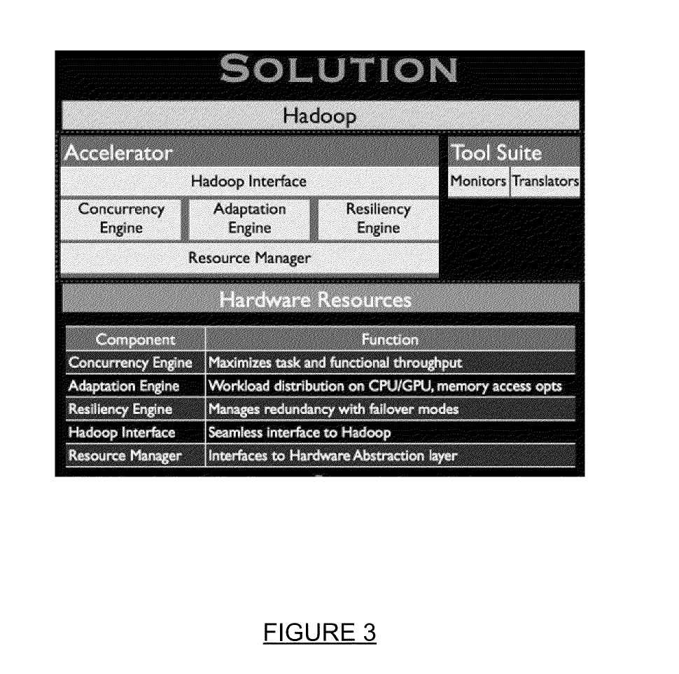

FIG. 3 is block diagram of exemplary software modules included in an exemplary accelerator. The software modules of the exemplary accelerator may include a Hadoop interface, a concurrency engine, an adaptation engine, a resiliency engine, and a resource manager. A framework interface layer or FIL, shown as “Hadoop Interface” in FIG. 3, may perform the tasks that a JAVA virtual machine (JVM) normally expects.

The resource manager may abstract the hardware layer and make it available to the other software modules of the accelerator. The resource manager may include a logical client and a logical server and provides an interface between the Hadoop software and GPU. The framework interface may implement the client portion of the Multi-client/Server model of the driver software, and there is a client Tasktracker instance. The Hadoop software may communicate with the client portion of the resource manager. The server part of the resource manager controls the GPU cores on the device. The client and server may both be executed on the CPU of the device. The server communicates with the client, collects the jobs or tasks to be performed, and sends the jobs/tasks to the GPU. Upon job completion, the GPU notifies the server that the jobs are complete. The server may then collect the results from device memory locations and provide the results to the client, which then communicates the results to the Hadoop software.

The resource manager may communicate with the GPU, setup and manage the Client/Task Queue based on the information provided by the client, and communicate with the client. Communication with the GPU may include providing the GPU with the co-ordinates of the data in the GPU memory and the program to execute per thread and block, receive from the GPU the status of tasks in progress, and receive from the GPU the completion status and the co-ordinates of the results in the GPU memory. Communication with the client may include receiving per task co-ordinates of the data available in the shared memory and providing per task co-ordinates of the results available in the shared memory to the client.

The concurrency engine may function as a framework interface layer (FIL) to manage the communications between different layers and/or engines, such a as for example communication with the Hadoop framework infrastructure, GPU and so forth. The primary goals of the concurrency engine may include maintaining application level compatibility and making the Hadoop framework aware of the augmented power efficient hardware computing resources available by communicating with HAL layer. The concurrency engine may also determine and manage the number of concurrent tasks run in parallel on the hardware resources such as a GPU.

The adaptation engine may monitor and adapt the balance between the data and computer to dynamically restructure compute code and/or data size per computer task to maximize throughput. The adaptation engine monitors the GPU cores and determines strategies for utilizing the GPU cores. Hence, the adaptation layer may adapt the usage of the cores based on the performance of the cores, the GPU architecture, and other information. The Adaptation Engine may monitor the throughput and adapt GPU execution to get the maximum throughput.

The Resiliency Engine may check for task execution progress and perform program management, for example by restarting jobs on other GPU resources which are stalled, stuck, or slow moving tasks. The resiliency layer may block off portions of the CPU for taking overflow tasks, hung tasks, and other tasks that for some reason are not handled well by the GPU cores.

The clients primary functions are to communicate with the Tasktracker, move data from CPU only memory to shared memory, to move results from shared memory to CPU memory and communicate with the server. Communication with the Tasktracker may include informing the Tasktracker that the task has been accepted, informing the task tracker of the progress of the job, and informing the task tracker that the task has been completed. Communication with the server may include the configuration and set-up of a server flag to indicate that a task is available to process.

The present technology has many advantages. For example, the present technology can accelerate the computing performance of a Hadoop distributed framework data node, such as a Hadoop distributed framework data node, using software developed specifically to take advantage of additional computing resources added to the data node by way of an add-on hardware.

FIG. 4 is an exemplary flowchart for the present technology. A determination is made at a computing device within the Hadoop framework if the device includes additional hardware available for Hadoop acceleration. The additional hardware may include any processing hardware, such as for example a GPU, CPU or other hardware. If additional hardware is not available, tasks are distributed on the device CPU threads and handled by the CPU.

If additional hardware is available, a determination is made if code for utilizing the additional hardware by the acceleration software is installed and available. If the code is not available, the code may be created and installed by the accelerator software. The code may include libraries and other elements to be used by the acceleration software of the present invention, and may be created for the device CPU, any device GPUs, and other hardware that can be utilized by the accelerator software. Once the code is available, incoming tasks are distributed between the CPU and GPU. The present technology may configure the Hadoop cluster to configure the present node as a more powerful node which may handle a higher number of tasks.

Load balancing may be used to divide or partition tasks between the GPU and the CPU. In some embodiments, a plurality of tasks may be submitted to the GPU, for example for each GPU core, at a time. For example, if the GPU includes one hundred cores and there are two thousand tasks to process, the accelerator might provide twenty tasks to each core. In some embodiments, additional intelligence may be used to distribute the tasks. For example, if some cores are more powerful than others, the more powerful cores may be utilized to process more tasks than the less powerful cores. If a number of cores are used more often by the device, the busier cores may be sent less tasks then cores used less frequently. The number of tasks sent to each core and the CPU may depend on the processing capability and architecture of the GPU and/or CPU, number of tasks, the use of the cores by the device, and other parameters. The accelerator may also adapt its usage of the GPU cores and CPU to process tasks based on changes in core availability, core usage history, and other data.

Once the task processing is complete, the result is collected, packaged and sent back through the Hadoop framework.

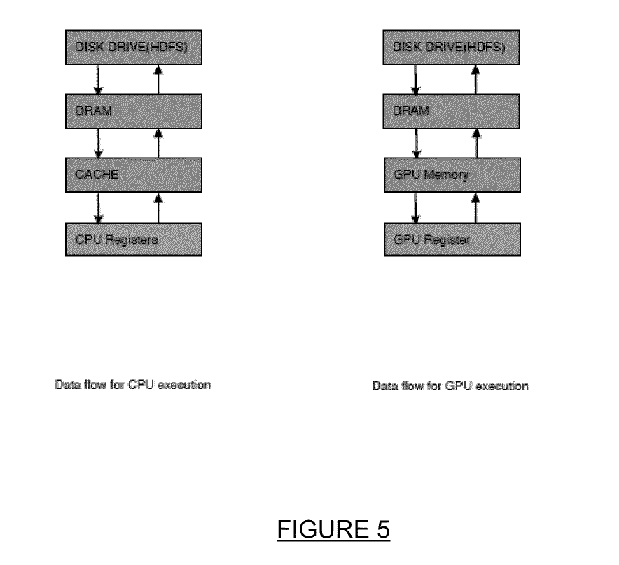

FIG. 5 is an exemplary data flow for CPU operation. Normal data flow for CPU operation involves moving data from a disk drive to DRAM, and then to a cache. CPU registers retrieve data from the cache, process the data, and then the data and/or results are placed back in the cache. In a GPU, the data is moved from disk drives to DRAM, and then to GPU memory. A GPU register than receives the data, the data is processed and then the data and/or results are provided back into GPU memory.

The present technology may also accelerate any number of data nodes in an “N” node distributed framework cluster, such as a Hadoop distributed framework cluster, by the software when installed on the data node to be accelerated and the appropriate hardware card is added to that data node.

A further advantage of the present technology is that the software on the data node may be targeted to make the resources of a parallel processing hardware subsystem available to the Hadoop distributed framework Tasktrackers, such as Hadoop Tasktrackers, such that many more task trackers can be started on the data node in parallel with assigned processing resources. This may result in making task threads execute truly in parallel on physical processing resources (see FIG. 4). The technology herein may interact with a distributed framework, such as Apache Hadoop, in such a way that the distributed framework is completely compatible to the framework's expectations.

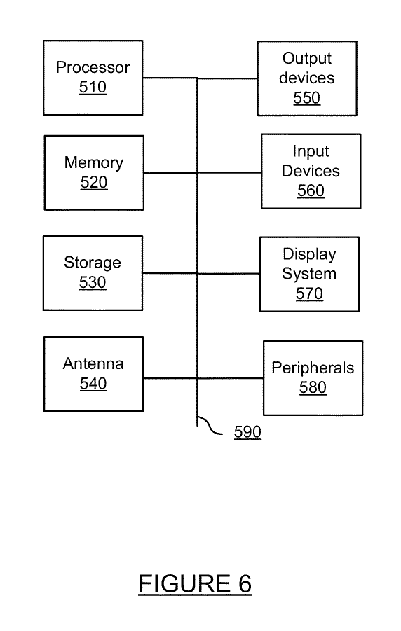

FIG. 6 is a block diagram of a device for implementing the present technology. FIG. 6 illustrates an exemplary computing system 600 that may be used to implement a computing device for use with the present technology. System 600 of FIG. 6 may be implemented in the contexts of the likes of severs and computing devices which implement the present technology. The computing system 600 of FIG. 6 includes one or more processors 610 and memory 620. Main memory 620 may store, in part, instructions and data for execution by processor 610. Main memory can store the executable code when in operation. The system 600 of FIG. 6 further includes a storage 620, which may include mass storage and portable storage, antenna 640, output devices 650, user input devices 660, a display system 670, and peripheral devices 680.

The processor may include one or CPUs, GPUs, or other hardware that can be utilized, including any processing unit that include multiple cores for performing data processing in parallel. An example of a suitable GPU may include an nVidia GTX 670 PCI Express 16 Card, nVidia 690 hardware, and nVidia Tesla hardware.

The components shown in FIG. 6 are depicted as being connected via a single bus 690. However, the components may be connected through one or more data transport means. For example, processor unit 610 and main memory 620 may be connected via a local microprocessor bus, and the storage 630, peripheral device(s) 680 and display system 670 may be connected via one or more input/output (I/O) buses.

Storage device 630, which may include mass storage implemented with a magnetic disk drive or an optical disk drive, may be a non-volatile storage device for storing data and instructions for use by processor unit 610. Storage device 630 can store the system software for implementing embodiments of the present invention for purposes of loading that software into main memory 610.

Portable storage device of storage 630 operates in conjunction with a portable non-volatile storage medium, such as a floppy disk, compact disk or Digital video disc, to input and output data and code to and from the computer system 600 of FIG. 6. The system software for implementing embodiments of the present invention may be stored on such a portable medium and input to the computer system 600 via the portable storage device.

Antenna 640 may include one or more antennas for communicating wirelessly with another device. Antenna 616 may be used, for example, to communicate wirelessly via Wi-Fi, Bluetooth, with a cellular network, or with other wireless protocols and systems. The one or more antennas may be controlled by a processor 610, which may include a controller, to transmit and receive wireless signals. For example, processor 610 execute programs stored in memory 612 to control antenna 640 transmit a wireless signal to a cellular network and receive a wireless signal from a cellular network.

The system 600 as shown in FIG. 6 includes output devices 650 and input device 660. Examples of suitable output devices include speakers, printers, network interfaces, and monitors. Input devices 660 may include a touch screen, microphone, accelerometers, a camera, and other device. Input devices 660 may include an alpha-numeric keypad, such as a keyboard, for inputting alpha-numeric and other information, or a pointing device, such as a mouse, a trackball, stylus, or cursor direction keys.

Display system 670 may include a liquid crystal display (LCD), LED display, or other suitable display device. Display system 670 receives textual and graphical information, and processes the information for output to the display device.

Peripherals 680 may include any type of computer support device to add additional functionality to the computer system. For example, peripheral device(s) 680 may include a modem or a router.

The components contained in the computer system 600 of FIG. 6 are those typically found in computing system, such as but not limited to a desk top computer, lap top computer, notebook computer, net book computer, tablet computer, smart phone, personal data assistant (PDA), or other computer that may be suitable for use with embodiments of the present invention and are intended to represent a broad category of such computer components that are well known in the art. Thus, the computer system 600 of FIG. 6 can be a personal computer, hand held computing device, telephone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Palm OS, and other suitable operating systems.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

What is claimed is:

1. A method for providing a computing node, comprising:
accessing a data node in a distributed framework with processing hardware not utilized by the distributed framework;
installing a software module on the data node to interact with the processing hardware;
accelerating performance of the data node within the distributed framework based on the executing software module and the processing hardware.

2. The method of claim 1, wherein the distributed framework is a Hadoop framework.

3. The method of claim 1, wherein multiple nodes in an multi-node cluster within the framework include the software module and processing hardware.

4. The method of claim 1, wherein the software module is executable to make resources of a parallel processing hardware subsystem available to one or more distributed framework task trackers, the one or more task trackers executed on the data node in parallel with assigned processing resources.

5. The method of claim 1, wherein the processing hardware includes a graphics processing unit.

6. The method of claim 1, further comprising distributing tasks on a central processing unit.

7. The method of claim 1, further comprising distributing tasks on a graphics processing unit.

8. A non-transitory computer readable storage medium having embodied thereon a program, the program being executable by a processor to perform a method for communicating player information, the method comprising for providing a computing node, comprising:
accessing a data node in a distributed framework with processing hardware not utilized by the distributed framework;
installing a software module on the data node to interact with the processing hardware;
accelerating performance of the data node within the distributed framework based on the executing software module and the processing hardware.

9. The non-transitory computer readable storage medium of claim 8, wherein the distributed framework is a Hadoop framework.

10. The non-transitory computer readable storage medium of claim 8, wherein multiple nodes in an multi-node cluster within the framework include the software module and processing hardware.

11. The non-transitory computer readable storage medium of claim 8, wherein the software module is executable to make resources of a parallel processing hardware subsystem available to one or more distributed framework task trackers, the one or more task trackers executed on the data node in parallel with assigned processing resources.

12. The non-transitory computer readable storage medium of claim 8, wherein the processing hardware includes a graphics processing unit.

13. The non-transitory computer readable storage medium of claim 8, further comprising distributing tasks on a central processing unit.

14. The non-transitory computer readable storage medium of claim 8, further comprising distributing tasks on a graphics processing unit.

15. A system for providing a computing node, comprising:
a processor;
memory; and
one or more modules stored in memory and executable by the processor to access a data node in a distributed framework with processing hardware not utilized by the distributed framework, install a software module on the data node to interact with the processing hardware, and accelerate performance of the data node within the distributed framework based on the executing software module and the processing hardware.

16. The system of claim 15, wherein the distributed framework is a Hadoop framework.

17. The system of claim 15, wherein multiple nodes in an multi-node cluster within the framework include the software module and processing hardware.

18. The system of claim 15, wherein the software module is executable to make resources of a parallel processing hardware subsystem available to one or more distributed framework task trackers, the one or more task trackers executed on the data node in parallel with assigned processing resources.

19. The system of claim 15, wherein the processing hardware includes a graphics processing unit.

20. The system of claim 15, the one or more modules further executable to distribute tasks on a central processing unit.

21. The system of claim 15, the one or more modules further executable to distribute tasks on a graphics processing unit.
